(19) United States
(12) Patent Application Publication
(10) Pub. No.: US 2025/0211450 A1
(43) Pub. Date: Jun. 26, 2025

(54) METHOD FOR PROVIDING A COMPUTER-IMPLEMENTED FUNCTIONALITY IN A COMPUTING SYSTEM

(71) Applicant: Robert Bosch GmbH, Stuttgart (DE)

(72) Inventors: Christian Zimmermann, Stuttgart (DE); Paulius Duplys, Markgroeningen (DE)

(21) Appl. No.: 18/983,073

(22) Filed: Dec. 16, 2024

(30) Foreign Application Priority Data
Dec. 21, 2023 (DE) 10 2023 213 131.5

(51) Int. Cl. H04L 9/32; H04L 9/08

(52) U.S. Cl. CPC H04L 9/3247; H04L 9/0819

(57) ABSTRACT

A method for providing a computer-implemented functionality in a computing system having at least one computing unit and one security module. The method includes signing, by the security module, a provision request specifying a requested functionality, using an authorization key stored by the security module; sending the signed provision request to an access manager; checking, by the access manager, the authenticity of the signed provision request; if the check is successful, sending, by the access manager, an access key for the requested functionality to the computing system; sending a container request for the requested functionality to a repository that stores a functionality container with the requested functionality; and, if the validity of the access key is confirmed, implementing, by the at least one computing unit, the functionality using the functionality container in the computing system.

### FIELD

The present invention relates to a method for providing a computer-implemented functionality in a computing system, a method that is performed in a computing system, and a computing unit and a computer program for performing the method.

### BACKGROUND INFORMATION

Functionalities implemented in vehicles may be defined by software, wherein control units execute computer programs in order to implement certain functionalities. The computer program parameters may be modifiable in order to change the scope of a functionality. For example, different power levels may be parameterized in an engine control program for the engine of the same vehicle. Different functionalities may also be implemented for the same vehicle by different computer programs. For example, an autonomous driving function, for example automatic parking, may or may not be implemented, depending on whether or not a corresponding computer program is installed/enabled, while the vehicle remains otherwise unchanged. Such differences in the functionalities provided may also depend on the particular users of the vehicle.

### SUMMARY

According to the present invention, a method for providing a computer-implemented functionality in a computing system as well as a method that is performed in a computing system, along with a computing unit and a computer program for performing said method, are provided. Advantageous example embodiments of the present invention are disclosed herein.

In a method for providing a computer-implemented functionality in a computing system having at least one computing unit and one security module, an example embodiment of the present invention makes use of the measure of signing, by the security module, a provision request specifying a requested functionality, using an authorization key stored by the security module, and sending said provision request to an access manager. Once the authenticity of the signed provision request has been successfully checked, the access manager sends an access key for the requested functionality to the computing system. Furthermore, a container request for the requested functionality is sent to a repository that stores a functionality container with the requested functionality and, after or if the validity of the access key is confirmed, the functionality is implemented in the computing system using the functionality container.

By means of the present invention, access to a large number of different functionalities requiring authorization for implementation is made possible, wherein only a single authorization key or a relatively small number of authorization keys (e.g., specific to certain users of the vehicle) is/are stored by the security module. It is not necessary to store a large number of keys that corresponds to the number of different functionalities.

According to an example embodiment of the present invention, the method is performed in a system that has the computing system, the access manager and the repository.

The term “cryptographic key” or simply “key” is used to describe character strings that are used in cryptographic methods. These character strings should be sufficiently random so that they can only be determined by guessing or brute-force attacks (if they are not known).

According to one example configuration of the present invention, the container request contains the access key and, for confirming the validity of the access key, the method comprises checking, by the repository, the validity of the access key; and, if the validity check is successful, transmitting, by the repository, the functionality container to the computing system. This is expedient since the access key is confirmed by a system that is independent of the computing system.

According to one example configuration of the present invention, in which the functionality container in the repository is cryptographically protected, in particular encrypted, so that implementation of the functionality is not possible without knowledge of the access key, the method for confirming the validity of the access key comprises transmitting, by the repository, the protected functionality container to the computing system in response to the container request, and removing, in particular decrypting, by the computing system, the cryptographic protection of the functionality container using the access key. In this configuration, the container request along with the transmission of the functionality container can be carried out before the provision request (i.e., before signing and/or sending the provision request).

According to one example configuration of the present invention, the access manager sends the access key as an encrypted access key to the computing system. This encryption of the access key can be in addition to the encryption of the message in which the access key is sent to the computing system. In particular, this makes possible configurations in which the (unencrypted) access key is only known in the security module.

According to one example configuration of the present invention, if applicable, the encrypted access key is decrypted by the security module and temporarily stored by the security module, without being transmitted to a computing unit or another module of the computing system, and the access key is inserted into the container request by the security module, wherein the container request is encrypted by the security module after this insertion. According to this configuration, the container request can be generated without the requesting, possibly compromised, computing unit gaining access to the access key.

According to one example configuration of the present invention, if applicable, the encrypted access key is decrypted by the security module and temporarily stored by the security module, without being transmitted to a computing unit or another module of the computing system, wherein the cryptographic protection of the functionality container is removed by the security module. Here as well, it is possible to prevent the (unencrypted) access key from becoming known in the computing system outside the security module.

According to one example configuration of the present invention, in which the computing system has a communication module, communication with the access manager and the repository is carried out via the communication module. Communication with the access manager and the repository comprises sending the signed provision request, receiving the access key as part of sending the access key to the computing system, sending the container request to the repository and, if applicable, receiving the functionality container from the repository. The communication module is a central unit in the computing system via which messages are exchanged with external systems. The communication module can be configured to exchange data within the computing system only with the at least one computing unit. As a result, the use of a security module that meets very high security requirements, e.g., a hardware security module, is made possible. Alternatively, it may be provided that the communication module is configured to exchange data within the computing system with the at least one computing unit and with the security module. As a result, data exchange in the computing system is simplified so that, in particular, less computing power and/or data bandwidth is required for a bus used for data exchange.

According to one example configuration of the present invention, sending the provision request and/or sending the access key and/or sending the container request and/or, if applicable, transmitting the functionality container is carried out in cryptographically protected form, wherein each message is encrypted and/or signed. As a result, the authenticity and integrity of messages can in particular be confirmed, and attackers are prevented from gaining access to transmitted data, e.g., from obtaining knowledge of the access key or becoming aware of requested functionalities.

According to one example configuration of the present invention, the encryption and/or signing and/or decryption and/or signature check of messages in the computing system is/are carried out by the security module, wherein the cryptographic keys used are stored by the security module. Using the security module is expedient since it is typically particularly protected against attacks. The security module can store keys, for example in an internal and/or security-module-specific memory and/or in a separate memory area of an external memory, which is accessible only to the access module.

According to one example configuration of the present invention, the provision request and/or the container request is/are generated by one of the at least one computing unit of the computing system, in particular the one by which the requested functionality is to be implemented. Accordingly, the process is controlled by the computing unit.

According to one example configuration of the present invention, the functionality container contains a program module and/or program parameters. The program module (or computer program module) can be executed by the computing unit in order to implement the functionality. Program parameters can be used to change the functionality of already installed program modules.

A method according to an example embodiment of the present invention, which is performed in a computing system having at least one computing unit and one security module, comprises signing, by the security module, a provision request specifying a requested functionality, using an authorization key stored by the security module; sending the signed provision request to an access manager; receiving an access key for the requested functionality from the access manager; sending a container request for the requested functionality to a repository that stores a functionality container with the requested functionality. Either the container request contains the access key and the method comprises receiving the functionality container from the repository and implementing the functionality by the at least one computing unit using the functionality container; or the functionality container is received as a cryptographically protected functionality container from the repository and the method comprises removing the cryptographic protection of the functionality container using the access key and implementing the functionality by the at least one computing unit using the functionality container.

According to an example embodiment of the present invention, the method, which is performed in a computing system having at least one computing unit and one security module, can furthermore comprise method steps mentioned in the present application in relation to the system comprising the computing system, the access manager and the repository, to the extent that they are performed by the computing system.

A computing unit according to the present invention, e.g., a control unit of a motor vehicle, is configured, in particular programmatically, to perform a method according to the present invention.

Furthermore, the implementation of a method according to the present invention in the form of a computer program or computer program product having program code for performing all the method steps is advantageous since it is particularly low-cost, in particular if an executing control unit is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and example embodiments of the present invention can be found in the disclosure herein.

The present invention is shown schematically in the figures on the basis of exemplary embodiments and is described below with reference to the figures.

### BRIEF DESCRIPTION OF THE DRAWINGS

FIG. 1 shows, by way of example, the structure of a system in which the method according to an example embodiment of the present invention can be implemented.

FIG. 2 shows a flow chart of the method according to one example embodiment of the present invention.

FIG. 3 shows a flow chart according to a general example embodiment of the present invention.

### DETAILED DESCRIPTION OF EXAMPLE EMBODIMENTS

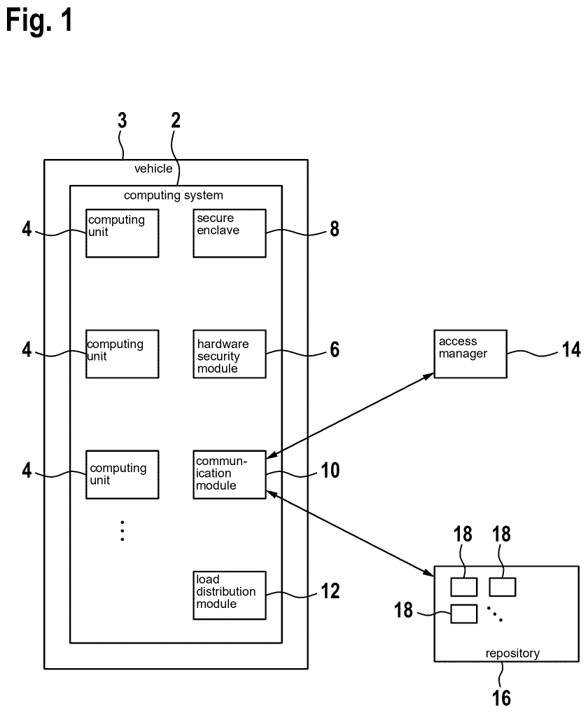

FIG. 1 shows, by way of example, the structure of a system in which the method according to the present invention can be implemented.

A computing system 2 is shown, in particular in a vehicle 3, which comprises a plurality of computing units or computing modules. In detail, computing units 4 (or control units) are shown, which implement certain functionalities of the vehicle 3 by executing computer programs, for example in the form of computer program modules or computer program containers. Three computing units are shown by way of example. In general, any number of computing units can be provided. In this application, the terms “program module” and “program container” are also used for the terms “computer program module” and “computer program container,” respectively.

Furthermore, security modules are shown, wherein a hardware security module 6 and a secure enclave 8 in a computing unit, for example based on a TPM (trusted platform module or the like), are shown by way of example. A security module provides security-relevant functions in the computing system and serves as a trust anchor, i.e., cryptographic functions provided by the security module and/or (cryptographic) keys or the like stored by the security module are considered to be trustworthy or to be protected against manipulation. At least one security module is provided for the method according to the present invention. In addition to their function as trust anchors, security modules can be configured to execute the provided cryptographic functions at high speed, for example by implementing them using hardware circuits.

A (central) communication module 10 is provided, which is configured to implement communication of data between the vehicle 3 or the computing system 2 and (vehicle-) external computers or systems, for example by means of radio connections or mobile radio connections (for example by means of Wi-Fi or by means of a 3G, 4G, 5G or 6G connection).

A load distribution module 12 can be provided, which is configured to distribute computing loads (in particular the execution of certain program modules) between the computing units 4 depending on the utilization of individual computing units.

The computing units 4, the security modules 6, 8, the communication module 10 and, if applicable, the load distribution module 12 are shown in FIG. 1 as separate units or modules by way of example. In general, the computing units and/or computing modules, or functions provided by them, can be provided at least partially together in one computing unit. In particular, a security module (hardware security module 6, secure enclave 8) can be provided or implemented in one of the computing units 4. Likewise (and independently of the security module), the communication module 10 can be provided or implemented in one of the computing units 4. If applicable, the load distribution module 12 can be provided or implemented in one of the computing units 4 (independently of the security module and the communication module).

The system of FIG. 1 also has an access manager 14 (or rights manager) and a repository 16 for functionality containers 18. Both are remote from or external to the vehicle and its computing system. The access manager 14 is provided in a computer and/or computer system, for example a server and/or a server system. Likewise, the repository 16 is provided (independently of the access manager) in a computer and/or computer system, for example a server and/or a server system. These computers and/or computer systems are connected to a data communication system (for example the Internet) and are configured to exchange data with the vehicle or the communication module 12 via the data communication system. Data communication is thus possible both between the vehicle or the communication module 12 and the access manager 14 and between the vehicle or the communication module 12 and the repository 16.

Authorization information, based on which it can be determined which functionalities can be provided by a computing system, is stored by the access manager 14. The authorization information comprises one or more cryptographic keys (or key information), designated as confirmation keys. Each of the confirmation keys can be used as part of a cryptographic method to check the authenticity of provision requests. Provision requests are sent by computing systems (such as the one shown) to the access manager and received by said access manager. In particular, each provision request contains an indication of at least one requested functionality that is to be provided in the particular computing system. One or more functionalities are assigned to each confirmation key in the authorization information, wherein, if the authenticity of a provision request is confirmed during the check with the confirmation key, the sender of the provision request (i.e., the computing system that sent the provision request to the access manager) is authorized to use or implement the one or more functionalities. An asymmetric cryptographic method can be used as the cryptographic method for checking the authenticity of provision requests, wherein a provision request is signed (by the sender of the provision request) with a cryptographic key designated as an authorization key, which forms a key pair with the confirmation key, and is checked with the confirmation key (by the access manager).

If the authenticity of a provision request is confirmed during the check with the confirmation key and if the at least one requested functionality contained in the provision request is contained in the one or more functionalities assigned to the confirmation key, the access manager 14 determines that the sender is authorized to implement the at least one requested functionality. In this case, the access manager 14 sends a message with an access key (access code or token) to the sender (computing system) of the provision request. In particular, sending the access key is carried out in encrypted form. The access key can be specific to the sender of the provision request, e.g., can be derived from a general access key, wherein information contained in the provision request is received.

If the at least one requested functionality contained in the provision request is not contained in the one or more functionalities and/or if the authenticity of a provision request is not confirmed during the check with the confirmation key, the access manager 14 can determine that the sender is not authorized to implement the at least one requested functionality. In this case, the access manager 14 can be configured not to send a message to the sender (computing system) of the provision request or to send a message with an indication that the provision request has failed.

The repository 16 stores functionality data or functionality containers 18 for a plurality of computer-implemented functionalities. In general terms, functionality containers contain data that make it possible for a computing system or its computing units to provide (at least) one functionality. Functionality containers 18 may, for example, be in the form of an executable program module and/or in the form of program parameters. A program module may, for example, be installed and executed in a computing unit in order to provide a corresponding functionality. Program parameters can be used to parameterize an already installed program module and to influence its execution, for example, so that different functionalities according to different parameterizations are in principle provided. Access keys are assigned to each of the functionality containers 18.

The repository 16 is configured to receive messages, designated as container requests, each of which includes at least one access key and optionally specifies at least one requested functionality container, and to transmit to the sender of the container request the at least one functionality container 18 to which the at least one access key is assigned, or after checking whether the at least one access key is valid for the at least one requested functionality container (e.g., is assigned to it). In particular, the container requests are encrypted.

According to an alternative or additional configuration, it can be provided that the repository 16 is configured, in response to a message, also designated as a container request, in which at least one functionality container 18 is requested, to transmit the at least one requested functionality container 18 to the sender of the container request, wherein the container request does not contain an access key and/or this is not checked. In this configuration, the functionality containers 18 are cryptographically protected, i.e., a recipient of a functionality container cannot initially implement the functionality provided therein. Only when the access key corresponding to the functionality container is known is it possible to implement the functionality provided by the functionality container. For example, the functionality container can be encrypted, wherein the access key can be used for decryption.

Both procedures can be regarded as steps with which the validity of the access key is confirmed. In any case, the functionality can only be used or implemented once the access key has been confirmed as valid. In the first of these procedures, the confirmation is carried out directly by the repository. In the second procedure, the confirmation is carried out indirectly on the part of the recipient (computing system or computing unit) of the (cryptographically protected) functionality container.

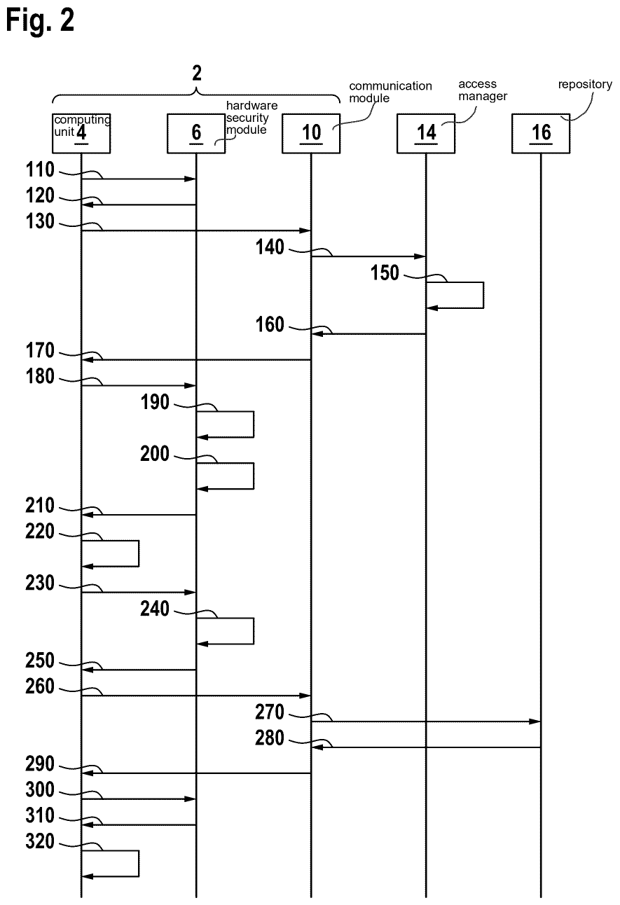

FIG. 2 shows a flow chart of the method according to one embodiment of the present invention. This embodiment represents a configuration of the first of the aforementioned procedures. It is a system corresponding to that shown in FIG. 1, wherein a computing unit 4, a security module in the form of a hardware security module 6, a communication module 10, an access manager 14 and a repository 16 are shown in columns. As explained in connection with FIG. 1, the computing unit 4, the hardware security module 6 and the communication module 10 are comprised in a computing system 2 (in particular of a vehicle). Instead of a hardware security module 6, another security module, e.g., a secure enclave 8, can also be used. Steps of the method are illustrated by arrows.

By means of the method shown, a desired computer-implemented functionality is to be provided by the computing unit 4 in the computing system 2 or the vehicle.

In step 110, the computing unit 4 initially creates a provision request for the desired functionality and transmits a request to the hardware security module 6 to sign the provision request. The hardware security module 6 signs the provision request by means of an authorization key stored by the hardware security module 6 and, in step 120, transmits the signed provision request to the computing unit 4 (or informs it where the signed provision request is stored, or that the signature is present, for example if corresponding predetermined memory areas are provided).

The computing unit 2 transmits the signed provision request to the access manager 14. In step 130, the signed provision request is initially transmitted by the computing unit 2 to the communication module 10, or the computing unit 2 informs the communication module 10, with an indication of a memory area, that the signed provision request is to be transmitted to the access manager 14. In step 140, the communication module 10 transmits the signed provision request to the access manager 14.

In step 150, the access manager 14 checks the authenticity of the received (signed) provision request, wherein, as explained in connection with FIG. 1, a confirmation key is used. If the authenticity (and thus the authorization of the computing system to implement the functionality) is confirmed during the check (valid signature), the access manager 14 transmits a corresponding access key in encrypted and in particular signed form to the communication module 10 of the computing system 2 in step 160.

The encrypted and, if applicable, signed access key is transmitted in step 170 from the communication module 10 to the computing unit 4, which transmits it to the hardware security module 6 in step 180. In step 190, the hardware security module 6 decrypts the encrypted access key, wherein the signature of the access key is checked if applicable.

In step 200, the HSM 6 encrypts the (decrypted) access key and optionally signs for the encrypted access key. This encryption is, for example, carried out using a symmetric encryption method with a key that is in particular only known to the HSM 6 and the computing units of the computing system, so that, for example, attackers who listen in on the data traffic in the computing system cannot gain possession of the key. Furthermore, a key that is only known to the requesting computing unit 4 (and the HSM) can be used so that other computing units in the computing system cannot gain possession of this key.

The access key that the HSM 6 encrypted and, if applicable, signed6 is transmitted to the computing unit 4 in step 210. The HSM 6 also stores the (decrypted) access key (for further use in step 240). The computing unit 4 verifies the encrypted and, if applicable, signed access key, wherein, in particular, the digital signature (which was, if applicable, generated by the HSM) of the key is verified.

In the case of a successful verification, the computing unit 4 transmits a message to the HSM 6 in step 230 with an indication (or path indication) to a storage location of the requested functionality container, which contains the computer-implemented functionality to be provided by the computing unit 4 in the vehicle or computing system, and a specification of the requested functionality container. This indication is in particular a uniform resource locator (URL). This transmission can be carried out in a cryptographically protected manner, i.e., the message with the indication can be signed and optionally encrypted by the computing unit.

The HSM 6 can verify the message with the indication of the storage location and the specification of the requested functionality container (i.e., check its signature) and decrypt it if applicable. In step 240, the HSM 6 supplements the message with the indication of the storage location and the specification of the requested functionality container with an encrypted version of the access key (which was temporarily stored in the HSM in step 210) in order to obtain a container request. The encryption for obtaining the encrypted version of the access key is carried out in such a way that only the repository 16 can decrypt it. For example by means of an asymmetric encryption method, wherein a public key is used for the encryption.

The message supplemented by the encrypted version of the access key (container request) is transmitted in step 250 from the HSM 6 to the computing unit 4, which transmits it to the communication module 10 in step 260. These transmissions can again be protected by means of a signature. The communication module transmits, if applicable after (successful) verification of the signature, the message, or at least the specification of the requested functionality container and the encrypted version of the access key, in step 270 as a container request to the storage location indication contained in the message, i.e., to the repository 16.

The repository 16 decrypts the encrypted version of the access key, for example with a private key of the asymmetric encryption method mentioned in step 240, checks whether the access key is valid for the requested functionality container (i.e., is assigned to it), and, if the check is successful, transmits the functionality container to the computing system 2, i.e., its communication module 10, in step 280. This transmission is carried out in a signed manner and optionally in an encrypted manner.

In step 290, the communication module 10 transmits the signed and, if applicable, encrypted functionality container to the computing unit 2, which in turn transmits it to the HSM 6 in step 300. The HSM 6 checks the signature of the functionality container and decrypts it if applicable. If the check is successful, the functionality container is transmitted by the HSM 6 to the computing unit 4 in step 310 (optionally again protected by a signature and/or encryption).

In step 320 (if applicable after the check of the signature and/or decryption), the computing unit 4 implements the functionality provided in the functionality container. This means that, if the functionality container contains a program module, said program module is stored in a suitable memory and the computing unit starts to execute this program module. If the functionality container contains program parameters, at least one program module already present in the computing unit is modified with these program parameters and executed with these program parameters.

In the configuration of FIG. 2, a hardware security module 6 is assumed, the functionality of which is substantially limited to providing predetermined cryptographic functions (e.g., decryption, encryption, signing, signature check) for the computing units 4. These functions are, for example, provided by a computing unit that requires a function transmitting the data to which the function is to be applied to the hardware security module 6 and invoking the hardware security module 6 to apply the function to the data. Transmitting the data to the hardware security module 6 can be carried out, for example, by the computing unit writing the data to which the function is to be applied into predefined memory areas of the hardware security module 6 or writing memory addresses, which indicate where the data to which the function is to be applied are stored, into predefined address registers (or the like) of the hardware security module 6. Cryptographic keys (or the like) used by the cryptographic functions are stored by the hardware security module 6 and, in particular, are not known to the computing unit. If a plurality of keys is stored by the hardware security module, the computing unit's invocation to the hardware security module to apply the function can contain an indication of which key is to be used. The keys are named in an appropriate manner, e.g., numbered.

Based on the functionality of such a hardware security module 6 being restricted to providing cryptographic functions, said hardware security module in particular cannot communicate with the communication module 10, nor can said communication module access the hardware security module, and thus cannot directly transmit data to be transmitted to other systems or received from other systems to the communication module or receive data therefrom. This results in the structure shown, in which data to which the HSM 6 applies a cryptographic function and which are to be transmitted to an external system are not transmitted by the HSM directly to the communication module 10 but are initially transmitted again to the computing unit and transmitted by said computing unit to the communication module, which communicates with the external system (e.g., steps 120 and 130 or steps 250 and 260). Likewise, data which are received from external systems by the communication module and to which a cryptographic function is to be applied by the HSM are not transmitted directly to the HSM but initially to the computing unit and then from there to the HSM (e.g., steps 170 and 180 or steps 290 and 300).

In other configurations, the security module can have extended functionality, wherein the security module can transmit data to the communication module or receive data from the communication module. In other words, communication or access between the communication module and the security module is then possible in the same or at least a similar manner (e.g., in a manner restricted to a subset) as between the computing unit and the security module. In this configuration, the intermediate step in which data are communicated between the security module and the computing module via the computing unit can be omitted (e.g., after step 110, the data, i.e., the signed provision request, are transmitted from the security module to the communication module instead of steps 120 and 130). Here, interaction between the computing unit, communication module, and security module is also conceivable, wherein, for example, the communication module transmits data to the security module and the computing unit initiates the application of a cryptographic function.

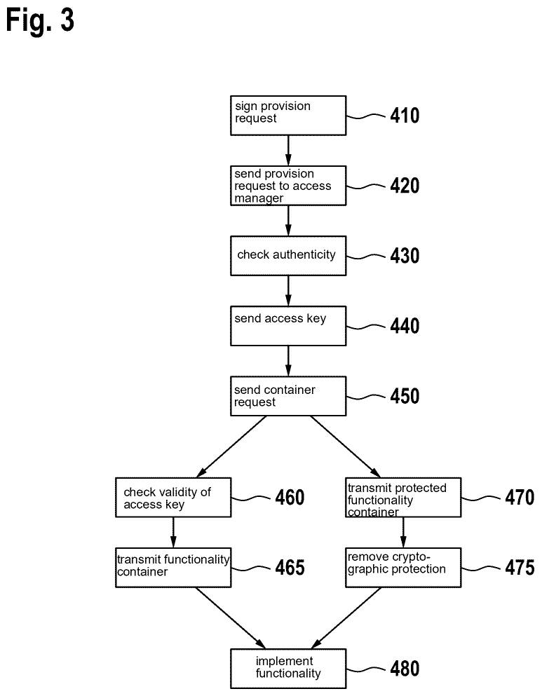

FIG. 3 shows a flow chart according to one embodiment of the present invention, in which naming the individual elements of the computing system that execute certain steps is largely dispensed with. The method relates to the provision of a computer-implemented requested functionality in a vehicle having a computing system with at least one computing unit and one security module.

In step 410, a provision request specifying a requested functionality is signed by the security module using an authorization key stored by the security module.

In step 420, the signed provision request is sent from the computing system to an access manager.

In step 430, a check of the authenticity of the signed provision request is carried out by the access manager.

In step 440, if the check is successful, sending an access key for the requested functionality to the computing system is carried out by the access manager. If the check is not successful, the access key is not sent to the computing system, wherein an error message or the like is optionally sent.

In step 450, a container request for requested functionality is sent to a repository that stores a functionality container with the requested functionality.

Depending on how the validity of the access key is to be confirmed (cf. the description of FIG. 1, in particular of the repository), various procedures are possible. The first procedure comprises steps 460 and 465. The second procedure comprises steps 470 and 475.

According to the first procedure, the container request contains the access key. In step 460, the repository checks the validity of the access key. In step 465, if the validity check is successful, the functionality container is transmitted by the repository to the computing system. If the check is not successful, the functionality container is not transmitted, wherein an error message or the like is optionally sent to the computing system.

According to the second procedure, the functionality container in the repository is cryptographically protected so that it is not possible to implement the requested functionality without knowing the access key. Cryptographic protection can in particular include encryption. In step 470, the protected functionality container is transmitted to the computing system by the repository in response to the container request. In step 475, the cryptographic protection of the functionality container is removed by the computing system using the access key. Removing the cryptographic protection comprises, in particular, decryption. In particular, steps 470 and 475 can be performed before step 420 or step 410 has been performed, i.e., prior to the provision request.

In step 480, if or after the validity of the access key is confirmed, the functionality is implemented in the computing system by the computing unit using the functionality container.

1-15. (canceled)

16. A method for providing computer-implemented functionality in a computing system having at least one computing unit and one security module, the method comprising the following steps:
signing, by the security module, a provision request specifying a requested functionality, using an authorization key stored by the security module;
sending the signed provision request to an access manager;
checking, by the access manager, an authenticity of the signed provision request;
based on the checking being successful, sending, by the access manager, an access key for the requested functionality to the computing system;
sending a container request for the requested functionality to a repository that stores a functionality container with the requested functionality; and
based on a validity of the access key being confirmed, implementing, by the at least one computing unit, the functionality using the functionality container in the computing system.

17. The method according to claim 16, wherein the container request contains the access key, and the method further comprises confirming the validity of the access key, including:
checking, by the repository, the validity of the access key; and
based on the validity check being successful, transmitting, by the repository, the functionality container to the computing system.

18. The method according to claim 16, wherein the functionality container in the repository is cryptographically protected, so that the implementation of the requested functionality is not possible without knowledge of the access key, and wherein the method further comprises confirming the validity of the access key including:
transmitting, by the repository, the protected functionality container to the computing system in response to the container request; and
removing, by the computing system, the cryptographic protection of the functionality container using the access key.

19. The method according to claim 16, wherein the access key is sent as an encrypted access key to the computing system by the access manager.

20. The method according to claim 19, wherein the container request contains the access key, and the method further comprises confirming the validity of the access key, including:
checking, by the repository, the validity of the access key; and
based on the validity check being successful, transmitting, by the repository, the functionality container to the computing system;
wherein the encrypted access key is decrypted by the security module and temporarily stored by the security module, without being transmitted to a computing unit or another module of the computing system, wherein the access key is inserted into the container request by the security module; and wherein the container request is encrypted by the security module after the insertion.

21. The method according to claim 19, wherein the functionality container in the repository is cryptographically protected, so that the implementation of the requested functionality is not possible without knowledge of the access key, and wherein the method further comprises confirming the validity of the access key including:
transmitting, by the repository, the protected functionality container to the computing system in response to the container request; and
removing, by the computing system, the cryptographic protection of the functionality container using the access key;
wherein the encrypted access key is decrypted by the security module and is temporarily stored by the security module, without being transmitted to a computing unit or another module of the computing system; wherein the cryptographic protection of the functionality container is removed by the security module.

22. The method according to claim 16, wherein the computing system includes a communication module, wherein communication with the access manager and the repository is carried out via the communication module, wherein communication with the access manager and the repository includes sending the signed provision request, receiving the access key as part of sending the access key to the computing system, sending the container request to the repository and, receiving the functionality container from the repository.

23. The method according to claim 18, wherein the sending of the provision request and/or the sending of the access key and/or the sending of the container request and/or, the transmitting of the functionality container, is carried out in cryptographically protected form, wherein each message is encrypted and/or signed.

24. The method according to claim 23, wherein the encryption and/or the signing and/or decryption and/or a signature check of messages in the computing system are carried out by the security module, wherein cryptographic keys used are stored by the security module.

25. The method according to claim 16, wherein the provision request and/or the container request is generated by at least one computing unit of the computing system.

26. The method according to claim 16, wherein the functionality container contains a program module and/or program parameters.

27. A method performed in a computing system having at least one computing unit and one security module, the method comprising:
signing, by the security module, a provision request specifying a requested functionality, using an authorization key stored by the security module;
sending the signed provision request to an access manager;
receiving an access key for the requested functionality from the access manager;
sending a container request for the requested functionality to a repository that stores a functionality container with the requested functionality;
wherein: (i) the container request contains the access key and the method further comprises: receiving the functionality container from the repository and implementing the functionality by the at least one computing unit using the functionality container; or (ii) functionality container is received as a cryptographically protected functionality container from the repository and the method further comprises: removing the cryptographic protection of the functionality container using the access key and implementing the functionality by the at least one computing unit using the functionality container.

28. A computing system configured to provide computer-implemented functionality, the computing system including at least one computing unit and one security module, the computing system configured to:
sign, by the security module, a provision request specifying a requested functionality, using an authorization key stored by the security module;
send the signed provision request to an access manager;
check, by the access manager, an authenticity of the signed provision request;
based on the checking being successful, send, by the access manager, an access key for the requested functionality to the computing system;
send a container request for the requested functionality to a repository that stores a functionality container with the requested functionality; and
based on a validity of the access key being confirmed, implement, by the at least one computing unit, the functionality using the functionality container in the computing system.

29. A non-transitory machine-readable storage medium on which is stored a computer program for providing computer-implemented functionality in a computing system having at least one computing unit and one security module, the computer program, when executed by the computing system, causing the computing system to perform the following steps:
signing, by the security module, a provision request specifying a requested functionality, using an authorization key stored by the security module;
sending the signed provision request to an access manager;
checking, by the access manager, an authenticity of the signed provision request;
based on the checking being successful, sending, by the access manager, an access key for the requested functionality to the computing system;
sending a container request for the requested functionality to a repository that stores a functionality container with the requested functionality; and
based on a validity of the access key being confirmed, implementing, by the at least one computing unit, the functionality using the functionality container in the computing system.
